(19) United States
(12) Patent Application Publication
(10) Pub. No.: US 2023/0079425 A1
(43) Pub. Date: Mar. 16, 2023

(54) SYSTEM AND METHOD OF OPTIMIZED DYNAMICAL ALLOCATION OF DISPLAY RESOURCES

(71) Applicant: ADSTRUC, INC., New York, NY (US)

(72) Inventors: JOSHUA PATRICK WARRUM, NEW YORK, NY (US); SAMUEL JAMES HERBERT, NEW YORK, NY (US); JOHN FRANCIS LARAMIE, NEW YORK, NY (US); ELIANE KABKAB, NEW YORK, NY (US); ANDREW JOSEPH SHULTS, NEW YORK, NY (US); ERIC ISAIAH JUSTUSSON, BROOKLYN, NY (US); NEAL RANJAN SHYAM, BROOKLYN, NY (US)

(21) Appl. No.: 17/986,684

(22) Filed: Nov. 14, 2022

Related U.S. Application Data
(63) Continuation-in-part of application No. 17/074,907, filed on Oct. 20, 2020.
Application No. 17/074,907 is a continuation-in-part of application No. 16/174,134, filed on Oct. 29, 2018, now abandoned.
Application No. 16/174,134 is a continuation-in-part of application No. 14/500,188, filed on Sep. 29, 2014, now abandoned.
Application No. 14/500,188 is a continuation-in-part of application No. 13/367,007, filed on Feb. 6, 2012, now abandoned.
(60) Provisional application No. 61/590,723, filed on Jan. 25, 2012.
(60) Provisional application No. 61/439,620, filed on Feb. 4, 2011.

(51) Int. Cl. G06F 9/50

(52) U.S. Cl. CPC G06F 9/5011; G06F 9/505; G06F 2209/503; G06F 2209/508

(57) ABSTRACT

A system to dynamically generate, monitor and optimize an allocation of resources includes a processor-based server to process requests received from the client devices. The processor-based server includes a server processor to generate the allocation of resource sharing one or more display devices selected based on an allocation criterion defined by the information emitter, target rating point goal, a geolocation, a format, and a quality coefficient of each display device in the set of available display devices. The server processor monitors availability of previously unavailable display devices and track real-time changes to the quality coefficients for each display device in the updated set. The server processor dynamically updates and optimizes the allocation of resources based on the updated quality coefficients for the updated set of available display devices.

### RELATED APPLICATIONS

This application is a continuation-in-part application of U.S. application Ser. No. 17/074,907 filed Oct. 20, 2020, which is a continuation-in-part of U.S. application Ser. No. 16/174,134 filed Oct. 29, 2018, which is a continuation-in-part application of U.S. application Ser. No. 14/500,188, filed Sep. 29, 2014, which is a continuation-in-part application of U.S. application Ser. No. 13/367,007, filed Feb. 6, 2012, which claims the benefit of U.S. Provisional Application No. 61/439,620, filed Feb. 4, 2011, and U.S. Provisional Application No. 61/590,723, filed Jan. 25, 2012, each of which is incorporated herein by reference in its entirety.

### FIELD OF THE INVENTION

The present invention relates to a process for directing an information signal towards a selected display device, and more specifically to systems and methods of optimized dynamical allocation of display devices among a set of display resources.

### BACKGROUND OF THE INVENTION

Allocation of resource are used to allocate services from many pools of display resources as possible, typically to receive proposals from new pools of display resources. An allocation of resources brings together many pools of display resources from a geographic region to achieve an optimal display allocation. However, deciding which of the pool of display resources to include in an allocation or a proposal supporting an allocation is difficult, especially as the number of selectable pools of display resources is high. As the difficulty increases, suitable pools of display resources may be easily missed, thereby resulting in a poorly executed an allocation of resources.

### OBJECT AND SUMMARY OF THE INVENTION

In accordance with an exemplary embodiment of the claimed invention, a system is provided to dynamically generate, monitor and optimize a display resources allocation. The system comprises a database aggregating a set of display devices from a plurality of display resource controllers, a plurality of processor-based client devices, a communications network, and a processor-based server processes requests received from the client devices over the communications network. Each client device is associated with an information emitter or a display resource controller. The processor-based server comprises a load balancer to decode the requests from the plurality of client devices, and transports responses to the plurality of client devices, and a server processor. The server processor is configured to generate an allocation comprising one or more display devices selected based on one or more of the information emitter objectives like target rating point goal, a geolocation, a format and a quality coefficient of each display device, in the set of available display resources. The server processor is configured to monitor availability of previously display devices and update the set of display resources. The server processor is configured to track real-time changes to the quality coefficient for each display device in the updated set of available display resources, to provide an updated quality coefficient for each display device in the updated set of available display devices. The server processor is configured to dynamically update and optimize the allocation of resources based on the updated quality coefficient of said each display device in the updated set of available display resources

In accordance with an exemplary embodiment of the claimed invention, the aforesaid server processor determines the quality coefficient of each display device from a weighted arithmetic mean of a plurality of quality coefficients derived from metadata or metrics of each display device.

In accordance with an exemplary embodiment of the claimed invention, the format of each display device is a digital or non-digital display device, and the aforesaid server processor is configured to dynamically update and optimize prior to an activation of the allocation of resources for a set of non-digital display devices.

In accordance with an exemplary embodiment of the claimed invention, a system is provided for generating proposals for display devices. The system comprises a database aggregating multiple available display devices from a plurality of display resource controllers, a plurality of processor-based client devices, each associated with an information emitter or a display resource controller, a communications network, and a processor-based server. The processor-based server processes HTTP requests received from the client devices over the communications network, and comprises a server processor, a plurality of web servers, at least one postgres server, and a plurality of Resque workers. Each web server processes the HTTP requests, extracts data from the HTTP requests and generates an HTTP response to each HTTP request. The postgres server stores extracted data received from the web servers and provides stored data to the web servers. The server processor decodes and routes the HTTP requests from the client devices to one of the web servers, and transports the HTTP responses to the client devices. The Resque worker performs predefined jobs associated with each HTTP request. The Resque worker transmits emails to client devices associated with a display resource controller in response to an HTTP request comprising requirements for an allocation of resources from a client device associated with an information emitter. The Resque worker transmits emails to the client device associated with the information emitter in response to HTTP requests comprising proposals for the allocation of resources from the client devices associated with the display resources controller.

In accordance with an exemplary embodiment of the claimed invention, a system is provided for generating proposals for available display devices. The system comprises a database aggregating multiple available display devices from a plurality of display resource controllers, a plurality of processor-based client devices, each associated with an information emitter or a display resource controller, a communications network, and a processor-based server. The processor-based server processes HTTP requests received from the client devices over the communications network, and comprises a server processor, a plurality of web servers, at least one postgres server, and a plurality of Resque workers. Each web server processes the HTTP requests, extracts data from the HTTP requests and generates an HTTP response to each HTTP request. The postgres server stores extracted data received from the web servers and provides stored data to the web servers. The server processor decodes and routes the HTTP requests from the client devices to one of the web servers, and transports the HTTP responses to the client devices. The Resque worker performs predefined jobs associated with each HTTP request. The Resque worker transmits emails to client devices associated with display resource controller in response to an HTTP request comprising allocation information for one or more available display devices from a client device associated with an information emitter. The Resque worker transmits emails to the client device associated with the information emitter in response to HTTP requests comprising data relating to display devices' availability from the client devices associated with the display resource controller.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the claimed invention solely thereto, will best be understood in conjunction with the accompanying drawings in which:

FIG. 1 is a block diagram of a client-server system in accordance with an exemplary embodiment of the claimed invention;

FIG. 2A is a block diagram of a client device in accordance with an exemplary embodiment of the claimed invention;

FIG. 2B is a block diagram of a processor-based server in accordance with an exemplary embodiment of the claimed invention;

FIG. 3 is a block diagram of exemplary proposal engines in accordance with an exemplary embodiment of the claimed invention;

FIG. 4 is a block diagram of the system for generating a proposal in accordance with an exemplary embodiment of the claimed invention;

FIG. 5 a block diagram of the system for generating an assignment in accordance with an exemplary embodiment of the claimed invention;

FIG. 6 is a block diagram of the radar feature of the system for tracking changes in a quality coefficient in an allocation in accordance with an exemplary embodiment of the claimed invention;

FIG. 7 is a block diagram of the radar feature of the system for adding multiple allocations to an optimization pool in accordance with an exemplary embodiment of the claimed invention; and

FIG. 8 is a flow of chart of the Apache airflow process in accordance with an exemplary embodiment of the claimed invention.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

### DETAILED DESCRIPTION OF THE EMBODIMENTS

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The term “display device” can refer to a mean of displaying an information whether in electronic or physical (printed) form as well as data representative of the characteristics the display such as its location. That is a place where information emitter seeks an information to be displayed.

The term “client device” represents an information processor or device, such as personal digital assistant, tablet, laptop, PC, terminal, workstation, net book, mobile or smart phone, wireless device and other comparable web-enabled or communications-enabled device. The claimed invention is readily implemented by presently available communications apparatus and electronic components. The invention finds ready application in virtually all commercial communications networks, including, but not limited to an intranet, a local area network (LAN), a wide area network (WAN), world wide web, a telephone network, a wireless network, and a wired cable transmission system. The client device can access these communications network using BLUETOOTH®, WI-FI® and any other comparable means. BLUETOOTH is a registered trademark of Bluetooth SIG, Inc. and WI-FI is a registered trademark of Wi-Fi Alliance Corporation.

The term “targeted audience” as used herein refers to any information receiver capable receiving an information in an audience most desired by the information emitter that may be defined by age, sex, race, ethnicity or income, or their combinations for any geographic definition.

The term “target rating points” or “TRPs” as used herein refer to a number of criteria from a target audience delivered by an information display expressed as a percentage of information receivers.

The term “quality coefficient” or “QC” as used herein refers to a quality coefficient applied to a display device. Preferably, calculated from the weighted arithmetic mean of a plurality of quality coefficients derived from the display device metadata or metrics and information emitter characteristics related importance scores (weights). The term “quality coefficient (QC)” as used herein refers to a non-negative number which is used as a coefficient when weighting values for purposes of optimization. For example, a QC of 1 gives no special weight to the value, while a QC of 2 doubles the value and a QC of 0.5 halves the value.

The term “proposal” as used herein belongs to a specific allocation and contains the set of display resources available by a information emitter. An information emitter seeks of displaying an information on a set of display resource for itself or on behalf of another, and the information emitter will trigger the allocation of resources. The term “allocation” as used herein refers to the interval of time when a allocation of resources is run.

The term “flighting” or “flight dates” as used herein refers to the length of an allocation of resources, sometimes divided into distinct segments over the course of weeks. Flight Dates refers to the start and end date that the set of display resources will be allocated during the allocation.

The term “option” as used herein represents a collection of display devices that can be harnessed for an allocation by the information emitter.

A “pool of display resources” is a set of display resources controlled by a single resource controller in a set of display resources.

As used herein, “processor” and/or “engine” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

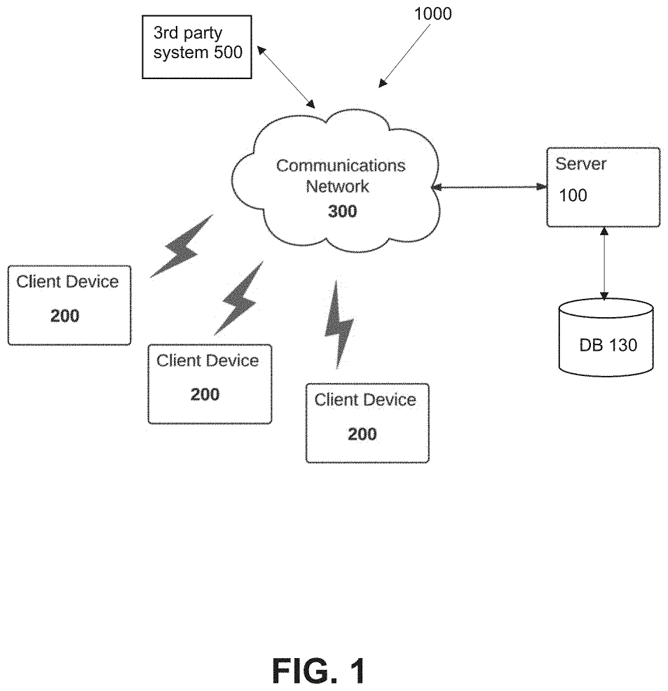

FIG. 1 shows a client-server system architecture in accordance with an exemplary embodiment of the claimed invention. As exemplary shown in FIG. 1, at the system level, the claimed invention comprises one or more web-enabled processor-based client devices 200, one or more processor-based servers 100, one or more databases 130, and a communications network 300. Each client device 200 is associated with a user, such as a display resource or an information emitter. Also, one or more third party systems 500 are connected to the server over the communications network 300, e.g., Internet.

In accordance with an exemplary embodiment of the claimed invention, a user is an information emitter or a display resource who engages in proposing or seeking allocation of a display devices. The user accesses the service provider's server 100 via the communications network 300 using a client device 200 by the user. The network 300 is a collection of computers, terminals and other hardware connected by communication channels allowing for the sharing of information. A server 100 executes or runs one or more active processes that respond and reply to client-side requests from the client device 200. A database 130 stores a large amount of organized data that is used for search and retrieval.

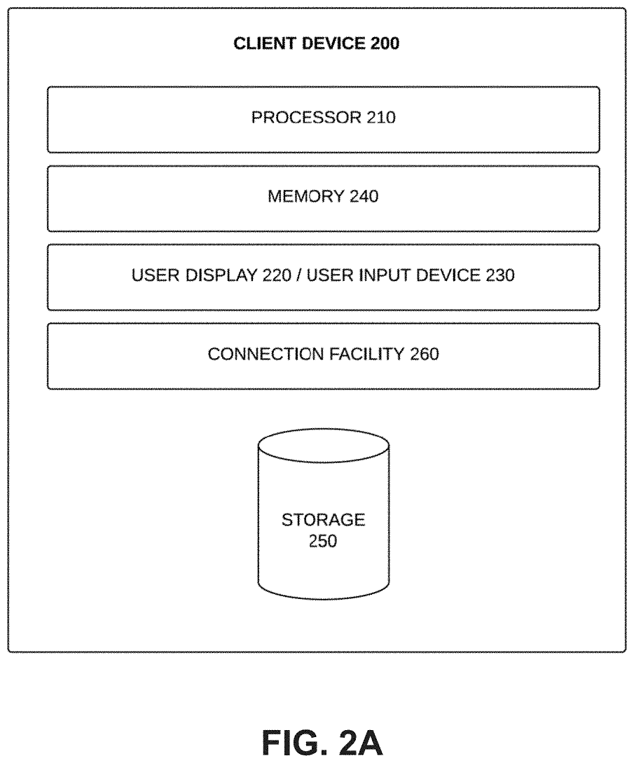

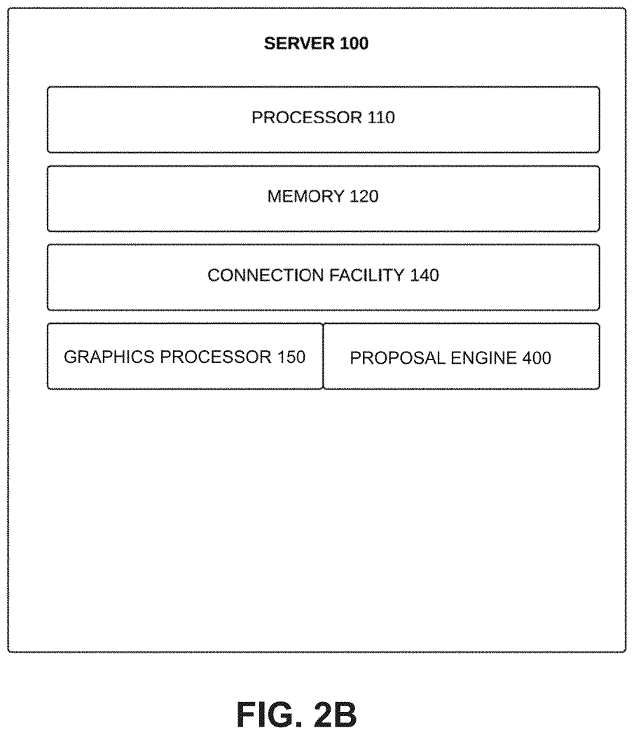

In accordance with an exemplary embodiment of the claimed invention, as shown in FIG. 2A, each client device 200 comprises a processor or client processor 210, a display or screen 220, an input device 230 (which can be the same as the display 220 in the case of touch screens), a memory 240, a storage device 250 (preferably, a persistent storage, e.g., hard drive), and a connection facility 260 to connect to the communications network 300.

In accordance with an exemplary embodiment of the claimed invention, as shown in FIG. 2B, the server 100 comprises a processor or server processor 110, a memory 120, a connection facility 140 to connect to the communications network 300, and a graphics processor 150. A server 100 includes but is not limited to a computer system, a single server, or a cluster or collection of computers or servers, or a cloud of computers or servers. Typically, a cluster or collection of servers can be used when the demand on the system 1000 exceeds the reasonable capability of a single server 100.

The user uses a processor-based client device 200 to access the application/program running on the processor-based server 100 over a communications network 300. The network enabled client device 200 includes but is not limited to a computer system, a personal computer, a laptop, a workstation, a terminal, a notebook, a netbook, a tablet or tablet like device, an iPad® (IPAD is a registered trademark of Apple Inc.) or iPad like device, a cell phone, a smart phone, a personal digital assistant (PDA), a mobile device, or a television, or any such device having a screen connected to the communications network 300 and the like. It is appreciated that the communications network 300 can be public or private network.

The communications network 300 can be any type of electronic transmission medium, for example, including but not limited to the following networks: a telecommunications network, a wireless network, a virtual private network, a public internet, a private internet, a secure internet, a private network, a public network, a value-added network, an intranet, a wireless gateway, or the like. In addition, the connectivity to the communications network 300 may be via, for example, by cellular transmission, Ethernet, Token Ring, Fiber Distributed Datalink Interface, Asynchronous Transfer Mode, Wireless Application Protocol, or any other form of network connectivity.

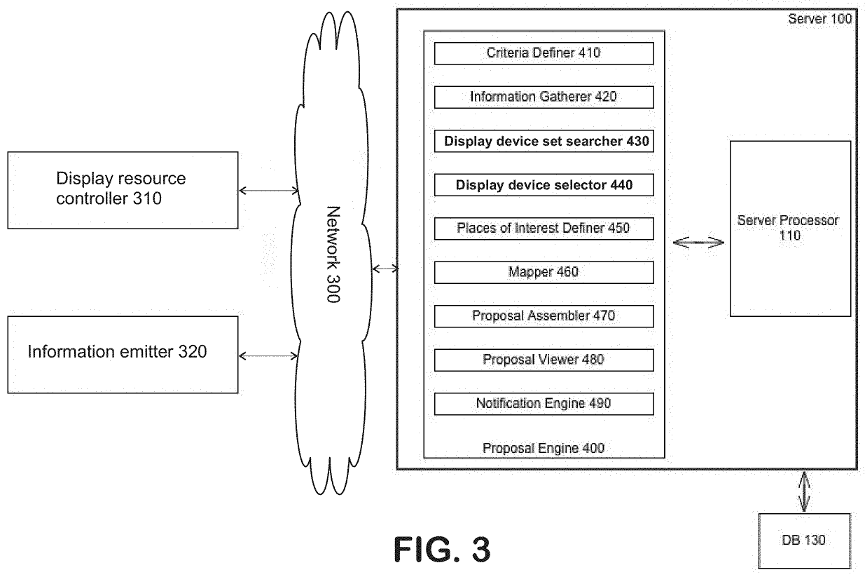

The system 1000 comprises one or more databases 130 aggregating multiple available display devices and one or more processor-based servers 100, preferably one or more web-based servers 100, configured to communicate with the database 130 and to generate proposals. As exemplary shown in FIG. 3, in accordance with an exemplary embodiment of the claimed invention, the server 100 comprises various proposal engines 400 to generate the proposals under the command and control of the server processor 110. These proposal engines 400 include but not limited to a criteria definer 410, an information gatherer 420, a display device set searcher 430, a display device selector 440, a reference locations or points of interest (POI) definer 450, a mapper 460, a proposal assembler 470, and a notification engine 490. The server 100 additional comprises a proposal viewer 480 to provide the client devices 200 access to the generated proposals.

The server processor 110 accesses and/or instructs the criteria definer 410 to define one or more criteria from which to select one or more display devices, and the one or more display devices can be suitable for implementing an allocation of resources associated with an information emitter. The server processor 110 accesses and/or instructs the information gatherer 420 to define information related to the information emitter and the allocation of resources. Meanwhile, the server processor 110 accesses and/or instructs the display device set searcher 430 to provide a selectable pool of display devices from the multiple available display devices based on the one or more criteria. The display device selector 440 is accessed and/or instructed by the server processor 110 to select the one or more display devices from the selectable pool of display devices. The reference locations definer 450 is accessed and/or instructed by the server processor 110 to define at least one reference location. The server processor 110 accesses and/or instructs the mapper 460 to map the one or more display devices and the at least one reference location to a map. The proposal assembler 470 is accessed and/or instructed by the server processor 110 to assemble (a) the information related to the information emitter and the resource allocation, (b) the map, and (c) the one or more display devices into a proposal. The proposal viewer 480, preferably, a graphical user interface (GUI), provides the client devices 200 access to proposals generated by the sever processor 110 over the communications network 300. The notification engine 490 provides provide notification of the generated proposal to one or more recipients over the communications network 300 via the connection facility 140.

In accordance with an exemplary embodiment of the claimed invention, the server processor 110, utilizing one or more proposal engines 400, generates a request for proposal (RFP) and/or one or more proposals (e.g., corresponding to the RFP). The proposal(s) can comprise one or more display devices that satisfy one or more criteria provided by a information emitter. Alternatively or in addition, the server processor 110 can locate (and/or provide as part of the proposal) one or more display devices associated with one or more places of interest (e.g., provided by the information emitter), such as, for example, one or more competing business establishments.

In accordance with an exemplary embodiment of the claimed invention, the server processor 110 utilizing one or more proposal engines 400 can generate the proposal for one or more pools of display devices, specifically, the server processor 110 transmits the proposal to client-devices 200 associated with the pool of display resources. The server processor 100 can generate RFPs and/or receive RFPs from a client device 200 associated with an information emitter interested in implementing an allocation of resources. The pool of display resources controller can access the server 100 over the communications network 300 using their client devices 200 to generate proposals in response to the RFP. It is appreciated that the pools of display resources controller can receive the RFP directly on their client devices 200 over the communications network 300 via the connection facility 140 from the server 100 (e.g., via an Internet portal associated with system 1000) and/or indirectly through any suitable communication medium (e.g., electronic mail messaging, short message service text messaging, social network messaging, etc.).

In accordance with an exemplary embodiment of the claimed invention, the database 130 can be implemented as any suitable computer database (e.g., XML (Extensible Markup Language) database, MySQL database, and/or Oracle® database). The database 130 can aggregate (and/or store) data associated with multiple available display devices and is organized in an efficient manner for querying and searching by the server processor 110. The multiple available display devices (a) can be associated with one or more pools of display resources and/or (b) can be managed by one or more third-party computer systems 500. Accordingly, in accordance with an exemplary embodiment of the claimed invention, the system 1000 can operate cooperatively and/or communicate with the third-party computer systems 500. Each third-party computer system 500 can manage one (or multiple) pools of display resources contributions/shares of available display devices to the multiple available display devices. Each pool of display resources controller can operate her respective available display devices, and each of the available display devices can be made available for inclusion in the proposals generated by the server processor 110. The database 130 can synchronize with one or more third-party computer system(s) 500 (e.g., periodically and/or in response to the occurrence of an event, such as, for example, upon generation of a request for an RFP by the server processor 110) to update and/or re-aggregate the multiple available display devices. Exemplary multiple available display devices can comprise multiple of (a) one or more available retail spaces, (b) one or more available sidewalk spaces for sidewalk vendor cart, (c) services, e.g., a service or maintenance contract, (d) goods, e.g., available cars for a new or used car dealership, computers to replace or upgrade existing office computers, office supplies.

In accordance with an exemplary embodiment of the claimed invention, the database 130 can also aggregate (and/or store) available display device information related to each available display device of the multiple display devices. Exemplary available display device information can comprise: (a) location, (b) foot traffic, (c) related demographic information (e.g., age(s) of a target audience, income(s) of the target audience, etc.), (d) identification number of the available display device, (h) showing information, (j) region, e.g., state, county, city, etc.

In accordance with an exemplary embodiment of the claimed invention, the database 130 can also store criteria defined by the criteria definer 410 and/or information related to the information emitter and the allocation of resources gathered by information gatherer 420. The criteria definer 410 and the information gatherer 420 are described in greater detail herein.

In accordance with an exemplary embodiment of the claimed invention, the server processor 110 accesses and queries the database 130 to retrieve information relating to a plurality of display devices, including but not limited to, availability of the display device, information relating to the display device, condition or criteria established by display resource/pool of display resources controller for selling or leasing the display device, information emitter's information, information emitter's allocation of resources requirements, as applicable, to generate one or more proposals. Alternatively or in addition, the server processor 110 communicates with the one or more third-party computer systems 500 and/or one or more computer systems 500 associated with the pool of display resources and/or information emitter over the communications network 300 to access the databases associated with such computer systems.

The users (e.g., information emitters and/or pool of display resources controllers) of system 1000 can directly access the server 100 to generate proposals using their client devices 200 over the communications network 300 via the connection facility 260. In accordance with an exemplary embodiment of the claimed invention, the system 1000 can be implemented as a centralized web-based service/platform that manages the utilization of a plurality of display devices for one or more pools of display resources, and/or that generate one or more proposals for utilizing such available display devices, such as in response to an information emitter's RFP(s) supporting an allocation of resources. Notwithstanding the manner in which the users of system 1000 access the proposal engine 400, the server processor 100 can facilitate the completion of the transactions, wherein the information emitter is able to allocate display devices in support of an allocation of resources. The server 100 and/or proposal engines 400 can be accessed by users over the communications network 300 via one or more graphical user interfaces on their client devices 200.

The connection facilities 140, 260 can comprise (a) one or more components configured to provide wired communication (e.g., one or more data buses, such as, for example, universal serial buses; one or more networking cables, such as, for example, coaxial cables, optical fiber cables, twisted pair cables; any other suitable data cable, etc.) and/or (b) one or more components configured to provide wireless communication (e.g., one or more radio transceivers, one or more infrared transceivers, etc.). The connection facilities 140, 260 can be configured to operate using any one or any combination of wired and/or wireless communication network topologies (e.g., ring, line, tree, bus, mesh, star, daisy chain, hybrid, etc.) and/or protocols (e.g., personal area network (PAN) protocols, local area network (LAN) protocols, wide area network (WAN) protocols, cellular network protocol(s), Powerline network protocols, etc.). Exemplary PAN protocols can comprise Bluetooth, Zigbee, Wireless Universal Serial Bus (USB), Z-Wave, etc.; exemplary LAN and/or WAN protocols can comprise Institute of Electrical and Electronic Engineers (IEEE) 802.3, IEEE 802.11, etc.; and exemplary wireless cellular network protocols can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc.

In accordance with an exemplary embodiment of the claimed invention, the criteria definer 410 defines (and/or stores in the database 130) one or more criteria from which to select one or more display devices. Preferably, the criteria definer 410 receives the criteria from (a) an information emitter, such as, for example, as an RFP and/or (b) from the pools of display resources controller (e.g., separately from the RFP). The criteria definer 410 and/or the server processor 110 determines the suitability of display devices for implementing an allocation of resources associated with the information emitter. Alternatively, or in addition, the criteria definer 410 receives additional criteria from the pools of display resources that may be attractive to the information emitter, though not necessarily required by or even known to the information emitter. These additional criteria can be used as additional points for the proposals. In addition to the receiving the criteria, the server processor 110 and/or criteria definer 410 can also receive a name for the RFP, a name of the information emitter, contact information for the information emitter, and/or any additional comments the information emitter has regarding the allocation of resources. In accordance with an exemplary embodiment of the claimed invention, the information emitter can provide the criteria via one or more graphical user interfaces associated with the criteria definer 410 displayed on the user display 220 of her client device 200.

Exemplary criteria can comprise (a) a budget of the information emitter, (b) an allocation of resources start date, (c) an allocation of resources end date, (d) a requested response date, (e) one or more allocation regions (e.g., cities, counties, states, etc.), and/or (g) other allocation details. Other allocation details can comprise any demographic information related to the target audience (e.g., gender, age range, income, residence, population), and any other desired metrics (e.g., identification numbers, tags, etc.) attractive to the information emitter. For example, the information emitter can be a used car dealership, and the allocation of resources can be directed to purchase of used vehicles to stock the dealership. For example, the target audience can be identified as males between the ages of 18-35 having an average income of approximately $60,000 and living in New York, New Jersey, or Connecticut. The one or more allocations of resources regions help to define the area or region within which the information emitter would like to limit the search for the desired goods. The population defines the number of persons living within the targeted area. The criteria can also comprise at least one place of interest (e.g., business establishments) to the information emitter.

In accordance with an exemplary embodiment of the claimed invention, the POI definer 450 defines the places of interest (e.g., as provided by an information emitter as part of an RFP). The POI definer 450 is also referred to herein as a references location definer 450, and the place(s) of interest can be referred to as reference location(s). The POI definer 450 receives the places of interest as locations designated on an interactive map by the user (e.g., an information emitter) using the user input device 230 of her client device 200. The interactive map can be generated and displayed on the user display 220 of the client device 200 by the mapper 460. The information emitter then selects the places of interest on the interactive map using the input device 230. The information emitter can also establish ranges (e.g., a radius) around the places of interest as part of the place(s) of interest criteria.

In accordance with an exemplary embodiment of the claimed invention, the pool of display resources controller can access the display device selector 440 of the server 100 over the communications network 300 using her client device 200 to select one or more display devices that meets the information emitter's criteria. In utilizing the display device selector 440, the pool of display resources controller can reference the interactive map, displayed on her client device 200, including the places of interest and/or ranges for each of the places of interest designated by the information emitter to select the appropriate display devices from a selectable pool of display devices, as described herein. The mapper 460 can map those available display devices of the multiple available display devices located within the ranges for each of the places of interest designated by the information emitter on the pool of display resources controller's client devices 200 to facilitate the pool of display resources controller's ability to select the display devices with the display device selector 460.

In accordance with an exemplary embodiment of the claimed invention, the server processor 110 is operable to utilize both the POI definer 450 and criteria definer 410 in defining the information emitter's criteria for selecting one or more display devices. For example, a information emitter can define one or more coffee establishments as places of interest on the interactive map and establish one-mile range around each of the coffee shops. Thus, where the information emitter competes with a coffee establishment, the pool of display resources controller can select one or more display devices, i.e., retail spaces, appropriate for competing with the coffee establishment.

In accordance with an exemplary embodiment of the claimed invention, the information gatherer 420 can define information related to the information emitter and the allocation of resources. The information related to the information emitter and the allocation of resources can be similar or identical to the criteria. The information gatherer 420 can receive the information related to the information emitter and the allocation of resources data (e.g., via text boxes and/or fields of one or more graphical user interfaces associated with the information gatherer 420 displayed on the user's client device 200) from the information emitter using her client device 200 to access the proposal engine 400 and/or from the database 130 (e.g., automatically populating the information based on the criteria stored at the database 130).

The display device set searcher 430 provides a selectable pool of display devices from the multiple available display devices based on the one or more criteria. In accordance with an exemplary embodiment of the claimed invention, the display device set searcher 430 applies the criteria against the multiple available display devices and filters out those display devices that satisfy the criteria, such as, for example, by comparing the criteria to the available display device information. Thus, the selectable pool of display resources can comprise display devices appropriate for the allocation of resources. That is, the display device selector 430 selects one or more display devices from the selectable pool of display resources, such as, for example, as provided for (e.g., selected) by the pool of display resources controller using her client device 200 to access the proposal engine 400. In accordance with an exemplary embodiment of the claimed invention, the display device set searcher 430 dynamically displays the selectable pool of display devices on the user display 220 of the pool of display resources controller's client device 200 from which the pool of display resources controller can select the one or more display devices on her client device 200 using the display device selector 440. The display device set searcher 430 can provide on the display 220 of pool of display resources controller's client device 200 a viewable picture of the display device, a location of the display device, and/or a description of the display device for each of the display devices of the selectable pool of display resources to aid the pool of display resources controller in selecting the display devices on the client device 200 with display device selector 440. Preferably, the selectable pool of display resources is dynamically displayed on the interactive map on the user display 220 of the pool of display resources controller's client device 200. Upon selecting one of the potential display devices from the selectable pool of display devices, the pool of display resources controller can view on the display 220 of her client device 200 the viewable picture, location, and/or description of the display device. Alternatively or in addition, the display device selector 440 is automated to select the display devices as opposed to the pool of display resources controller manually selecting the display devices.

In accordance with an exemplary embodiment of the claimed invention, the mapper 460 maps the display devices and/or the at least one place of interest to an interactive map displayed on the user display 220 of the client device 200. Preferably, the mapper 460 displays the proximity of the places of interest in relation to the display devices to be included within a proposal generated by the server processor 110 on the interactive map displayed on the client device 200. The mapper 460 also generates and displays an interactive map on the user display 220 of the information emitter's client device 200 from which the information emitter can select the places of interest by accessing the POI definer 450 using her client device 200. The interactive map used to select the places of interest can be the same interactive map upon which the mapper 460 maps the display devices.

In accordance with an exemplary embodiment of the claimed invention, the proposal assembler 470 assembles (a) the information related to the information emitter and the allocation of resources, (b) the map, and/or (c) the one or more display devices into a proposal. After the pool of display resources controller selects the available display devices on the pool of display resources controller client device 200 using the display device selector 440 to include in the proposal, the proposal assembler 470 assembles the proposal. In addition to (a) the information emitter related and allocation of resources information, (b) the map, and/or (c) the one or more display devices, the proposal assembler 470 can also include other suitable information in the proposal. For example, the proposal assembler 470 can include in the proposal any of the criteria (e.g., the budget of the information emitter), a total cost for the display devices over the duration of the allocation of resources (e.g., as defined by the allocation of resources start date and end date), an installation/establishment cost for the display devices, a total cost of the display devices included in the proposal (e.g., such that the information emitter is able to compare the total cost to the budget of the information emitter), etc. The pool of display resources controller can access the proposal viewer 480 with their client devices 200 to view the viewable pictures, locations, and/or descriptions of the display devices associated with the proposal. In accordance with an exemplary embodiment of the claimed invention, the proposal assembler 470 can also assemble the RFP provided by the information emitter via her client device 200 over the communications network 300.

In accordance with an exemplary embodiment of the claimed invention, the proposal viewer 480 provide access to the proposal (e.g., to the information emitter and/or the pool of display resources controller). For example, after proposal assembler 470 assembles the proposal, the proposal viewer 480 can make the proposal available to one or more intended recipients, such as, for example, via an Internet portal associated with system 1000. For example, the information emitter and/or pool of display resources controllers using their respective client device 200 can access the server 100 or a service provider's website including the proposal and located at the Internet portal by activating a unique link associated with the Internet website and providing access to the website. Preferably, the server processor 100 aggregates the proposals and any subsequently generated proposals for a given RFP into a unified proposal. For example, each time a pool of display resources controller responds to an information emitter's RFP, the notification engine 490 notifies the information emitter via her client device 200, e.g., the notification engine 490 transmits a text or an email to the information emitter and the server processor 100 integrates the pool of display resources controller's proposal into a single proposal (rather than multiple separate proposals). In accordance with an exemplary embodiment of the claimed invention, the information emitter can use her client device 200 to access the proposal viewer 480 over the communications network 300 to select and view any specific pool of display resources controller's proposal from the unified proposal stored in the database 130. Preferably, the proposal viewer 480 also provides the client devices 200 access to the RFPs stored in the database 130.

In accordance with an exemplary embodiment of the claimed invention, the notification engine 490 provides notification of the RFP and/or the proposal to one or more interested recipients, e.g., information emitters and/or pool of display resources controllers, on the notification list. Preferably, the notification engine 490 provides notification of the proposal to the recipients' client devices 200 via any suitable communication mechanism (e.g., electronic mail messaging, short message service (SMS) text messaging, social network messaging (e.g., a message board), etc.). Alternatively or in addition, the user can use her client device 200 to access the notification engine 490 over the communications network 300 to place herself or a recipient on the notification list. That is, the user can utilize one or more graphical user interfaces (GUIs) associated with the notification engine 490 displayed on her client device 200 to place herself or an intended recipient on the notification list by entering her information on the GUI displayed her client device 200 using the input device 230. For example, the pool of display resources controller can enter an electronic mail address of the intended recipient of the proposal (e.g., information emitter@company.com and/or information emitter2@company.com) on the GUI associated with the notification engine 490 displayed on her client device 200. Also, the notification engine 490 can include a personal message in the notification message by providing a text box or field on the GUI displayed on the user display 220 for entering the personal message by the user using the input device 230. In accordance with an exemplary embodiment of the claimed invention, the notification engine 490 only permits the pool of display resources controller to designate information emitters having submitted RFPs as recipients. Alternatively, the notification engine 490 permits the pool of display resources controller to designate any information emitters as recipients even if the information emitter did not submit an RFP.

In accordance with an exemplary embodiment of the claimed invention, the notification engine 490 automatically provides a unique link (and the personal message, when applicable) of the proposal to the recipients' client devices 200 via the relevant communication mechanisms. The notification engine 490 delivers the notification message, along with personal message if provided, to the client devices 200 of the specified and intended recipients. By clicking on the unique link, the server processor 110 connects the recipient's client device 200 to the server 100 or a secure website of the service provider displaying the pool of display resources controller's proposal.

In accordance with an exemplary embodiment of the claimed invention, the server processor 110 can process a transaction between the information emitter and one or more pools of display resources controller for one or more display devices. That is, if the information emitter is satisfied with the terms of the proposal, the information emitter can indicate her acceptance of the proposal using one or more graphical user interfaces associated with the server processor 110 displayed on display 220 of her client device 200.

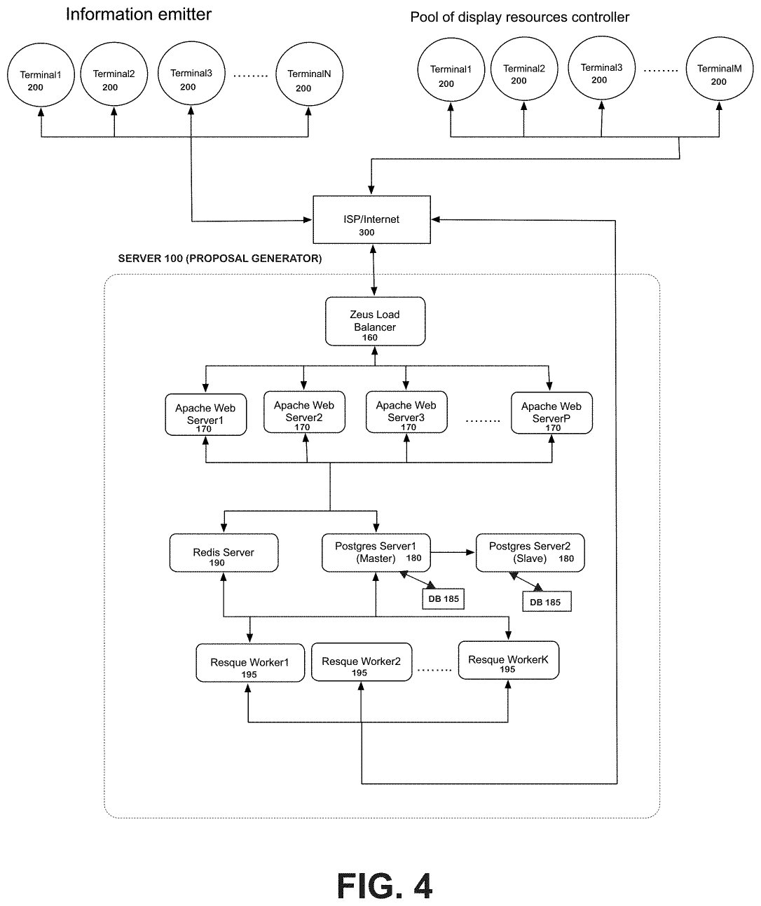

Turning now to FIG. 4, there is illustrated a schematic diagram of an exemplary system 1000 utilized in generating a proposal in accordance an exemplary embodiment of the claimed invention. The server processor 110 activates one or more proposal engines 400 to enable the pool of display resources controller to propose one or more display devices to the information emitter based on the information emitter's criteria previously established through the system 1000 and sent to the pool of display resources controller. The information emitter initiates a hypertext transfer protocol (“HTTP”) request from her client device 200 by entering the uniform resource locator (“URL”) of the server 100, preferably the URL of the server's proposal generator, in a web browser displayed on the user display 220 of her client device 200. The information emitter's HTTP request is transported over the communications network 300 (e.g., Internet) using a transmission control protocol (“TCP”) protocol to the server 100.

The server processor 110 directs the load balancer 160, preferably the Zeus load balancer 160, to decode and forward the incoming HTTP request to the appropriate web server 170, preferably Apache web server 170. The recipient Apache web server 170 decodes the information emitter's HTTP request and requests data from a postgres server 180. The server processor 110 stores the information emitter's HTTP request in the memory 120 and/or the database 185 associated with the postgres server 180. It is appreciated that the two postgres servers 180 are in master/slave configuration and the recipient Apache web server 170 requests data from the master postgres server 180.

In accordance with an exemplary embodiment of the claimed invention, the recipient Apache server 170 generates an appropriate hypertext markup language (“HTML”) template, e.g., GUI associated with the criteria definer 410, to be displayed on the display 220 of the information emitter's client device 200. That is, the server processor 110 activates the criteria definer 410 and transmits/transports the HTML template to the information emitter's client device 200 as an HTTP response over the communications network 300 using the TCP protocol via the connection facility 140. Also, the server processor 110 stores the HTML template in the memory 120 and/or the database 185.

The client processor 210 of the information emitter's client device 200 stores the received HTML template in the memory 240 and/or the storage device 250 and displays the received HTML template in a web browser of the information emitter's client device 200 to be viewed by the information emitter. The information emitter initiates an HTTP request from her client device 200 by entering information relating to one or more allocation of resources requirements to populate the HTML template using the input device 220 or the touch screen 220. Preferably, the client processor 210 stores the entered information and the HTTP request comprising the allocation requirements data in the memory 240 and/or storage device 250. The client processor 210 transmits/transports the HTTP request comprising the allocation requirements data to the server 100 over the communications network 300 using the TCP protocol via the connection facility 260.

The server 100 and/or the server processor 110 receives the information emitter's HTTP request comprising the allocation requirements data from the client device 200. The server processor 110 stores the received HTTP request comprising the allocation requirements data in the memory 120 and/or the database 185. The server processor 110 directs the load balancer 160, preferably the Zeus load balancer 160, to decode and forward the incoming HTTP request comprising the allocation requirements data to the appropriate web server 170, preferably Apache web server 170. The recipient Apache web server 170 decodes the information emitter's HTTP request comprising the allocation requirements data and transports/transmits the resultant or extracted data from the information emitter's HTTP request to the master postgres server 180. The master postgres server 180 stores the resultant or extracted data in its persistent storage device or database 185. Preferably, another or slave postgres server 180 also stores the resultant or extracted data in its persistent storage device or database 185 to provide redundancy.

In accordance with an exemplary embodiment of the claimed invention, the recipient Apache web server 180 generates asynchronous Resque jobs to send emails to sources and pull data (e.g., demographic and ratings, etc.) from external web application program interfaces (APIs) by sending configuration options in the form of keys to the Redis server 190. The Resque Workers 195 poll the Redis Server 190 to retrieve the relevant keys. The Resque Workers 195 perform the predefined jobs in accordance with the relevant keys and generate/transmit emails to the client devices 200 associated with the display source controller over the communications network 300 using the simple mail transfer protocol (“SMTP”) protocol.

In accordance with an exemplary embodiment of the claimed invention, display source controllers receive these emails on their client devices 200 and can initiate HTTP requests from their client devices 200 by entering the URL of the server 100, preferably the URL of the server's proposal generator, in a web browser displayed on their user displays 220 of their client devices 200. The sources' HTTP requests are transported/transmitted over the communications network 300 using the TCP protocol to the server 100.

The server processor 110 directs the Zeus load balancer 160 to decode and forward the incoming HTTP request to the appropriate Apache web server 170. The recipient Apache web server 170 decodes each source's HTTP request and requests data from the master postgres server 180. The server processor 110 stores the sources' HTTP requests in the memory 120 and/or the database 185 associated with the master postgres server 180.

In accordance with an exemplary embodiment of the claimed invention, the recipient Apache server 180 generates an appropriate HTML template to be displayed on the display 220 of the display source controller's client devices 200. The server processor 110 transmits/transports the HTML template to the display source controller's client device 200 as an HTTP response over the communications network 300 using the TCP protocol via the connection facility 140. Also, the server processor 110 stores the HTML template in the memory 120 and/or database 185.

The client processor 210 of the display source controller's client device 200 stores the received HTML template in the memory 240 and/or the storage device 250 and displays the received HTML template in a web browser of the display source controller's client devices 200 to be viewed by the respective display source controller. Each display source controller can initiate a HTTP request from her client device 200 by entering information relating to her proposal to populate the HTML template using the input device 220 or the touch screen 220. Preferably, the client processor 210 stores the entered information and the HTTP request comprising data relating to the proposal in the memory 240 and/or the storage device 250. The client processor 210 transmits/transports the HTTP request comprising data relating to the proposal to the server 100 over the communications network 300 using the TCP protocol via the connection facility 260.

The server 100 and/or the server processor 110 receives the display source controller's HTTP request comprising data relating to the proposal from her client device 200. The server processor 110 stores the received HTTP request comprising data relating to the proposal in the memory 120 and/or the database 185. The server processor 110 directs the Zeus load balancer 160 to decode and forward the incoming HTTP request comprising data relating to the proposal to the appropriate Apache web server 170. The recipient Apache web server 170 decodes each display source controller's HTTP request comprising data relating to her proposal and transports/transmits the resultant or extracted data from the display source controller's HTTP request to the master postgres server 180. The master postgres server 180 stores the resultant or extracted data in its persistent storage device or database 185. Preferably, another or slave postgres server 180 also stores the resultant or extracted data in its persistent storage device or database 185 to provide redundancy.

In accordance with an exemplary embodiment of the claimed invention, the recipient Apache web server 180 generates asynchronous resque jobs to send emails to the information emitter and pull data from external web APIs by sending configuration options in the form of keys to the Redis server 190. The Resque Workers 195 poll the Redis Server 190 to retrieve the relevant keys. The Resque Workers 195 perform the predefined jobs in accordance with the relevant keys and generate/transmit emails to the client device 200 associated with the information emitter over the communications network 300 using the SMTP protocol.

In accordance with an exemplary embodiment of the claimed invention, the information emitter receives these emails on her client device 200 and can initiate one or more HTTP requests for various operations described herein from her client device 200 as described herein by entering the URL of the server 100, preferably the URL of the server's proposal generator, in a web browser displayed on their user displays 220 of their client devices 200. The information emitter's HTTP requests are transported/transmitted over the communications network 300 using the TCP protocol to the server 100.

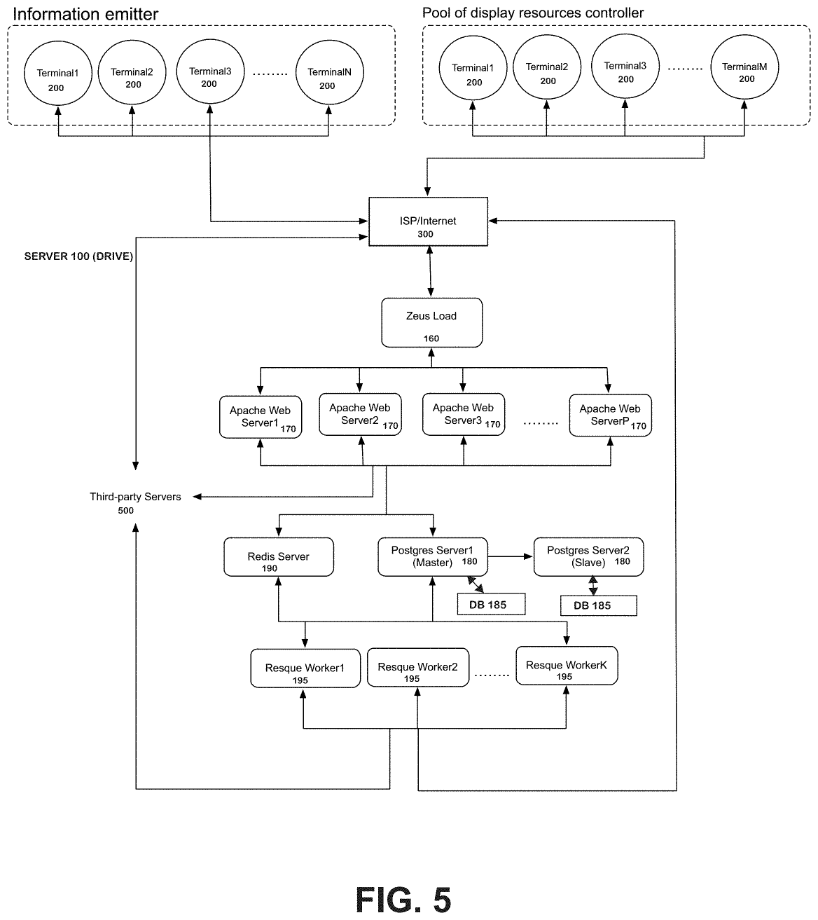

Turning now to FIG. 5, there is illustrated a schematic diagram of an exemplary system 1000 utilized in selecting display devices in accordance an exemplary embodiment of the claimed invention. The server processor 110 activates one or more proposal engines 400 to enable the information emitter to select one or more display devices and send an assignment request to the appropriate display source controller. The information emitter initiates a HTTP request from her client device 200 by entering the URL of the server 100, preferably the URL of the server's drive, in a web browser displayed on the user display 220 of her client device 200. The information emitter's HTTP request is transported over the communications network 300 using the TCP protocol to the server 100.

The server processor 110 directs the Zeus load balancer 160 to decode and forward the incoming HTTP request to the appropriate Apache web server 170. The recipient Apache web server 170 decodes the information emitter's HTTP request and generates Resque jobs to pull data (e.g., demographic and ratings, etc.) from the third-party servers 500 by sending configuration options in the form of keys to the Redis server 190. The Resque jobs execute synchronously and pull relevant data from the third-party servers 500 over the communications network 300 using the TCP protocol. The recipient Apache web server 170 also requests data from the master postgres server 180 to populate an HTML template. The server processor 110 transmits/transports the HTML template to the information emitter's client device 200 as an HTTP response over the communications network 300 using the TCP protocol via the connection facility 140. Also, the server processor 110 stores the information emitter's HTTP request and the HTML template in the memory 120 and/or the database 185 associated with the master postgres server 180.

The information emitter processor 210 of the information emitter's client device 200 stores the received HTML template in the memory 240 and/or the storage device 250 and displays the received HTML template in a web browser of the information emitter's client device 200 to be viewed by the information emitter. The information emitter initiates an HTTP request from her client device 200 by entering information relating to one or more display devices interested in allocation to populate the HTML template using the input device 220 or the touch screen 220. Preferably, the information emitter processor 210 stores the entered information and the HTTP request comprising the allocation information in the memory 240 and/or storage device 250. The information emitter processor 210 transmits/transports the HTTP request comprising the allocation information to the server 100 over the communications network 300 using the TCP protocol via the connection facility 260.

The server 100 receives the information emitter's HTTP request comprising the allocation information from the client device 200. The server processor 110 stores the received HTTP request comprising the purchasing information in the memory 120 and/or the database 185. The server processor 110 directs the Zeus load balancer 160 to decode and forward the incoming HTTP request comprising the allocation information to the appropriate Apache web server 170. The recipient Apache web server 170 decodes the information emitter's HTTP request comprising the allocation information and transports/transmits the resultant or extracted data from the information emitter's HTTP request to the master postgres server 180. The master postgres server 180 stores the resultant or extracted data in its persistent storage device or database 185. Preferably, another or slave postgres server 180 also stores the resultant or extracted data in its persistent storage device or database 185 to provide redundancy.

In accordance with an exemplary embodiment of the claimed invention, the recipient Apache web server 170 generates asynchronous Resque jobs to send emails to the display resource controller 310 and pull data (e.g., demographic, etc.) from the third-party servers 500 by sending configurations options in the form of keys to the Redis server 190. The Resque Workers 195 poll the Redis Server 190 to retrieve the relevant keys. The Resque Workers 195 perform the predefined jobs in accordance with the relevant keys and generate/transmit emails to the client devices 200 associated with the display resource controller 310 over the communications network 300 using the SMTP protocol.

In accordance with an exemplary embodiment of the claimed invention, display resource controllers 310 receive these emails on their client devices 200 and can initiate HTTP requests from their client devices 200 by entering the URL of the server 100, preferably the URL of the server's drive, in a web browser displayed on their user displays 220 of their client devices 200. The display resource controller's HTTP requests are transported/transmitted over the communications network 300 using the TCP protocol to the server 100.

The server processor 110 directs the Zeus load balancer 160 to decode and forward the incoming HTTP request to the appropriate Apache web server 170. The recipient Apache web server 170 decodes each display resource controller's HTTP request and requests data from the master postgres server 180. The server processor 110 stores the display resource controller's HTTP requests in the memory 120 and/or the database 185 associated with the master postgres server 180.

In accordance with an exemplary embodiment of the claimed invention, the recipient Apache server 180 generates an appropriate HTML template to be displayed on the display 220 of the display resource controller's client devices 200. The server processor 110 transmits/transports the HTML template to the display resource controller's client device 200 as an HTTP response over the communications network 300 using the TCP protocol via the connection facility 140. Also, the server processor 110 stores the HTML template in the memory 120 and/or database 185.

The client processor 210 of the display resource controller's client device 200 stores the received HTML template in the memory 240 and/or the storage device 250 and displays the received HTML template in a web browser of the display resource controller's client devices 200 to be viewed by the respective display resource controller 310. Each display resource controller 310 can initiate a HTTP request from her client device 200 by entering information relating to availability of the display devices desired by the information emitter 320 to populate the HTML template using the input device 220 or the touch screen 220. Preferably, the client processor 210 stores the entered information and the HTTP request comprising data relating to the display devices' availability in the memory 240 and/or the storage device 250. The client processor 210 transmits/transports the HTTP request comprising data relating to the display devices' availability to the server 100 over the communications network 300 using the TCP protocol via the connection facility 260.

The server 100 and/or the server processor 110 receives the display resource controller's HTTP request comprising data relating to the display devices' availability from her client device 200. The server processor 110 stores the received HTTP request comprising data relating to the display devices' availability in the memory 120 and/or the database 185. The server processor 110 directs the Zeus load balancer 160 to decode and forward the incoming HTTP request comprising data relating to the display devices' availability to the appropriate Apache web server 170. The recipient Apache web server 170 decodes each display resource controller's HTTP request comprising data relating to the display devices' availability and transports/transmits the resultant or extracted data from the display resource controller's HTTP request to the master postgres server 180. The master postgres server 180 stores the resultant or extracted data in its persistent storage device or database 185. Preferably, another or slave postgres server 180 also stores the resultant or extracted data in its persistent storage device or database 185 to provide redundancy.

In accordance with an exemplary embodiment of the claimed invention, the recipient Apache web server 170 generates asynchronous resque jobs to send emails to the information emitter 320 and pull data from the third-party servers 500 by sending configuration options in the form of keys to the Redis server 190. The Resque Workers 195 poll the Redis Server 190 to retrieve the relevant keys. The Resque Workers 195 perform the predefined jobs in accordance with the relevant keys and generate/transmit emails to the client device 200 associated with the information emitter 320 over the communications network 300 using the SMTP protocol.

In accordance with an exemplary embodiment of the claimed invention, the information emitter 320 receives these emails on her client device 200 and can initiate one or more HTTP requests for various operations described herein from her client device 200 as described herein by entering the URL of the server 100, preferably the URL of the server's drive, in a web browser displayed on their user displays 220 of their client devices 200. The information emitter's HTTP requests are transported/transmitted over the communications network 300 using the TCP protocol to the server 100.

In accordance with an exemplary embodiment of the claimed invention, the server processor 110 generates a mathematically optimized allocation recommendation to meet allocation goals of the information emitter 320. The server processor 110 considers the set's availability, geolocation, as well as the allocation budgets, target rating points (TRPs) goals, and an quality coefficient (QC) calculated from metadata and information emitter-supplied parameters.

The proposal viewer 480 allows information emitters 320 to view all sets in proposals generated by system on behalf of the vendors in one unified map, detail, and grid view. Along with many other functions, the proposal viewer 480 allows information emitters 320 to hide and like display resources and save the current state of the display resources in the allocation as an option which can be used to recommend which subset of the proposed display resources from all proposals should be assigned by the information emitter/information emitters 320 to meet their allocation goals. The server processor 110 can generate many options for a single allocation, representing different options for the information emitter 320. These options can be saved and viewed at a later date using the proposal viewer 480 or on the client device 200 over the network 300 via a secure link to the server 100 over the network 300. Options may also be copied, removed, and edited by an information emitter 320.

In accordance with an exemplary embodiment of the claimed invention, the process of the server processor 110 of algorithmically generating an allocation of resources plan can be picked up by an unsupervised job which will continuously run based on new data and suggest changes to the plans if the plan improves the target goal performance more than a user supplied threshold. As new display resources become available or weighted metrics change, the process runs and determines whether a new option should be presented to the user/information emitter.

In accordance with an exemplary embodiment of the claimed invention, the server processor 110 algorithmically generates an allocation of resources plan recommendation as follows:

1. An information emitter 320 initiates an HTTP (HyperText Transfer Protocol) request from her terminal 200 by entering the proposal viewer URL in a web browser.

2. The HTTP request is transported over the Internet 300 using the TCP protocol (Transmission Control Protocol).

3. The HTTP request is received by the proposal viewer 480.

4. A load balancer 180 decodes the incoming HTTP request and forwards it to an appropriate Apache Web Server 170.

5. The recipient Apache Web Server 170 decodes the HTTP request by executing relevant code.

6. The Apache Web Server 170 requests data from a Postgres Server (Master) 180.

7. The Apache Web Server 170 uses data from the Postgres server 180 to populate an HTML (HyperText Markup Language) template.

8. The HTML template is transported as an HTTP response over the Internet 300 using the TCP protocol.

9. The HTTP response is received by the information emitter's terminal 200.

10. The information emitter 320 views the template in a web browser on their terminal 200.

11. Additional HTTP requests are made by the JavaScript code on the information emitter's web browser asynchronously, repeating steps 4-6

12. The Apache Web Server 170 uses data from Postgres server 180 to generate JSON (JavaScript Object Notation) content.

13. The JSON content is transported as an HTTP response over the Internet 300 using the TCP protocol.

14. The JavaScript code interprets the JSON data and renders parts of the view in response.

15. The information emitter 320 instructs the server processor 110 to open a model containing a User Interface for the Algorithmic Resource Allocation Optimizer.

16. The information emitter 320 can select optimization criteria.

17. The server processor 100 executes the optimizer using a Knapsack Problem Algorithm (depending on criteria, the optimizer may run one of several variations) and returns the result in the form of the set of display resources selected to best meet optimization criteria. Knapsack Problem Algorithm is an algorithm that maximize the value to fit within the constraint or the selected optimization criteria.

18. The result is displayed as a summary view in the terminal display 220.

19. The information emitter can select preview plan and view the result on a map view using the mapper 460.

20. The information emitter 320 can save the result as a new Allocation Plan Recommendation (Option) or apply to the current Option currently loaded into proposal viewer 480.

21. The Option data to be saved is transported via HTTP request over the Internet 300 using the TCP protocol.

22. This HTTP request is received by the server 100 for option creation.

23. A load balancer 160 decodes the incoming HTTP request and forwards it to an appropriate Apache Web Server 170.

24. The recipient Apache Web Server 170 processes the incoming request by executing relevant code.

25. The resulting data is transported over to a Postgres Server (Master) 180 that persists the data inside a database 185 stored on a disk.

26. This data is replicated over to another Postgres Server (Slave) 180.

From proposal viewer 480, an information emitter 320 activates the pilot button which displays the Pilot modal dialog on the terminal display 220 to initiate the generation of the allocation of display resources plan recommendation by the server processor 110. In accordance with an exemplary embodiment of the claimed invention, the modal dialog includes the allocation title on the top, options and parameters for the optimizer on the left, and a summary view on the right which displays output from the optimization.

The information emitter/user fills out their parameters. As they change the parameters, a summary output from the recommendation engine is displayed on the right summary pane.

In the preview pane, the user sees a map view with the selected display devices shown. The user may go back to the start screen and change parameters or progress by outputting the result as a option. Either overwriting the existing option loaded in proposal viewer 480 or create a new option. If the new option is selected, the user enters a title and description for the new option. The proposal viewer reflects the applied option in the relevant context.

The server processor 110 utilizes the 0-1 Knapsack Problem Dynamic Programming Algorithm to maximize the display resource quality coefficient weighted criterion (QCCs) while staying within an information emitter's or information emitter's budget ceiling. As noted herein QCCs is the set of display resources quality coefficient (QC) multiplied by a defined criterion. Alternatively, the server processor 110 utilizes the 0-1 Knapsack Problem Dynamic Programming Algorithm to maximize QCCs while staying within the target rating points (TRPs) or defined criterion level ceiling if the information emitter wants to see what an optimal plan would look like and cost for a TRPs or defined criterion goal.

The “0-1” component of the Knapsack Problem Dynamic Programming Algorithm means that the set used by the algorithm cannot be split as pricing is not usually linear (e.g., 1 week price is not equal to 10 week price divided by 10) and the pools of display resources controllers are not always willing to sell their display resources for arbitrary lengths of time in the availability period (e.g., 3 days may not be an option). Pool of display resources controllers can propose the same Set as separate display devices with distinct flight dates and pricing to be included as distinct display devices to be assigned. The server processor 110 can use additional Knapsack algorithms to allow splitting of the values if allowed by the pool of display resources controller.

In the algorithm, the numb xᵢ of each Set of display resources is restricted to zero or one. Given a set of n items numbered from 1 up to n, each with a weight wᵢ and a value vᵢ, along with a maximum weight capacity W,

$${{\sum }_{i = 1}}^{n} {v}_{i} {x}_{i} maximize subject {{\sum }_{i = 1}}^{n} {w}_{i} {x}_{i} \underline{<} W to {x}_{i} ∈ \{ 0 , 1 \} and$$

Informally, the problem is to maximize the sum of the values of the items in the Knapsack so that the sum of the weights is less than or equal to the Knapsack capacity.

In accordance with an exemplary embodiment of the claimed invention, the server processor 110 assigns the parameters in the following way:
values=Price for each Set matching filters
weights=QCIs for each Set matching filters
capacity=Budget ceiling
or
values=TRPs for each Set matching filters
weights=QCIs for each Set matching filters
capacity=TRPs ceiling

Optimizer Options:

| | |
|---|---|
| Market | Only include Set that is in a specific Context. |
| Mode | Budget ceiling or TRPs ceiling |
| Other Options | Example: optionally exclude Set already hidden |
| | (disliked) by the information emitter. |
| QC Settings | Adjust the QC parameters. |

As noted herein, a quality coefficient (QC) is a non-negative number which can be multiplied with values being used for the purposes of weighting for optimization or sorting to give a measure of quality.

In accordance with an exemplary embodiment of the claimed invention, a QC is derived from the weighted arithmetic mean of a set of quality coefficients (QCs) and importance scores. Importance scores default to 1 (no weight) for any quality coefficients assigned to an attribute or computed value (metric). However, an information emitter 320 may adjust the definitions for QCs and the importance score when running optimizations.

Metrics can be information emitter defined (e.g., a subjective “wow-factor” score), an attribute (e.g., direction the ad is facing), or system provided (e.g., distance to closest POI).

An example of a QC definition (configurable by an information emitter) is shown below for a Distance to closest POI metric:
Distance to Closest POI
<0.02 miles=1.5
<0.1 miles=1.2
>0.4 miles=0.8

Additionally, the information emitter may decide that the importance of this metric is high for the allocation and assign it an importance score of 10 (the number isn't important)

For illustration purposes, we have assumed that the information emitter is using the following attributes and her QCs have been computed for a particular display device, as shown in Table 1. Additionally, the information emitter has set a relative importance score for each attribute to be used when calculating the QC.

TABLE 1

| Metric | QC | Importance |
|---|---|---|
| Distance to closest POI | 1.2 | 10 |
| Distance to subway | 0.8 | 3 |
| Liked previously | 1.1 | 8 |
| Proximity to traffic light | 0.9 | 2 |

The server processor 110 utilizes the values in Table 1 to calculate the QC for the optimization. For this case, the server processor calculates the following result:

(10*1.2+3*0.8+8*1.1+2*0.9)/(10+3+8+2)=1.08695652

Therefore, the display device quality coefficient for the values in Table 1 would be 1.08695652. This QC would weigh the quality of this display device slightly higher than normal based on the metrics definitions and relative importance scores assigned by the information emitter.

### EXAMPLES

The claimed system can generate optimized options, for given parameters and Table 2 of a Set or display resources proposed for an allocation in a given context along with QCs calculated using information emitter metric definitions and relative importance scores, as noted herein. Further, summary data can be shown in addition to the examples below, for example, the weighted average quality for the generated option or other metrics about the option.

TABLE 2

| Set ID | Price | Defined criteria | QC |
|---|---|---|---|
| A | $1,375 | 250,788 | 1.2 |
| B | $300 | 28,590 | 1 |
| C | $300 | 20,738 | 0.75 |
| D | $450 | 33,515 | 0.25 |
| E | $637 | 73,931 | 1.25 |
| F | $375 | 11,358 | 2.1 |

Set ID: a unique identifier for the set of display resources as proposed; Price: price for the set of display resources for a specified period; Defined criterion: as an exemplary embodiment the total number of time people are likely to notice a display device; and QC: pre-calculate for this example.

Option 1:

Input and Generated Option (simplified)

| | |
|---|---|
| Budget | $1,200 |
| Use IQS | No |
| Optimize for | Defined criterion |
| Option Cost | $1,087 |
| Option Set | D, E |
| Defined criterion | 107,446 |
| Cost per criteria | $10.12 |

Option 2:

Input and Generated Option (simplified)

| | |
|---|---|
| Budget | $1,200 |
| Use IQS | Yes |
| Optimize for | Defined criterion |
| Option Cost | $937 |
| Option Set | B, E |
| Criterions | 102,521 |
| Cost per criteria | $9.14 |

After an Allocation of Resources Plan Recommendation (option) 620 has been generated by the server processor 110, an information emitter 320 may leverage a radar function of the system which enables connectivity and utilization of real time and dynamic data sources such as social, mobile tracking, or customer orders to enable real time updates to QCs providing insights into the allocation before, during, and after the allocation is active.

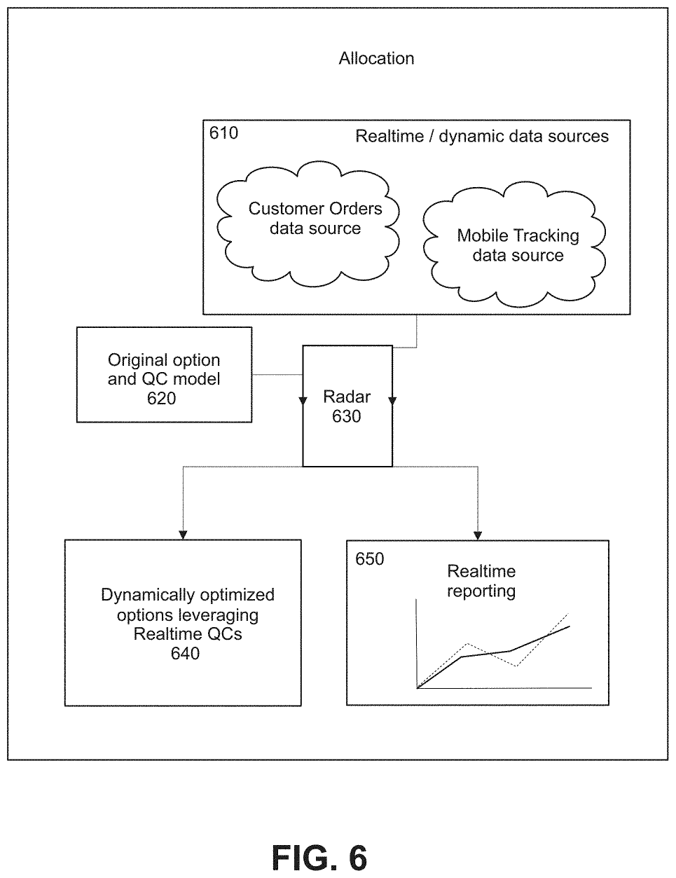

Turning now to FIG. 6, in accordance with exemplary embodiment of the claimed invention, the radar 630 enables the server processor 110 to track changes in QCs for the set in an allocation as new data 610 is collected (Realtime-QCs) as well as additional available set in the market and presents new dynamically updated options 640 to the information emitter 320. This enables the system to optimize the allocation assignments prior to allocation activation by the information emitter 320 and/or to optimize up until the due date for non-digital set of display resources or during an active allocation for a digital set of display resources.

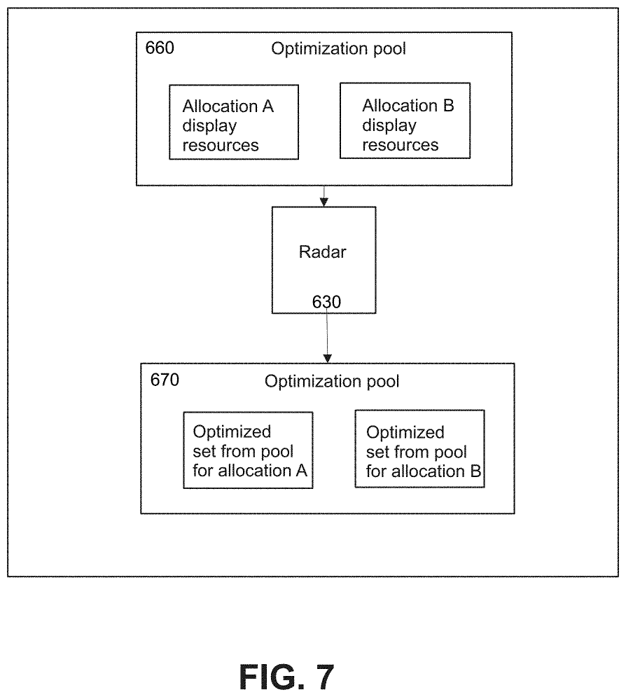

Additionally, as shown in FIG. 7, the radar 630 allows the information emitter 320 to add multiple allocations to an optimization pool 660, 670 which enables the server processor 110 to use Realtime-QCs to algorithmically suggest optimized exchanges of already-assigned set of display resources between the allocations to deliver against the target audience and other parameters for each allocation most effectively.

Additionally, during an allocation, the server processor 110 accesses and pipes real time or dynamic data 610 for attribution or other measurement such as a dataset of mobile device locations or customer orders into the radar 630 to provide real time metrics and reporting 650, such as how well the set of display resources is delivering against the allocation goals, e.g. increase in store visits.

This data is stored along with all other data related to the allocation and the Pilot recommendations in a data model library 130 which is used by the server processor 110 for future allocations to suggest QC metrics and weightings using machine-learning techniques, constantly improving the algorithms automatically over time.

In accordance with an exemplary embodiment of the claimed invention, the Apache airflow is used for scheduling and coordinating the DAGs (Directed acyclic graph) related to the tasks involved in the process. A Celery pool is used for managing worker servers. AWS Lambda is used for highly parallelized “serverless” jobs such as image processing. PostgresQL is used as a general-purpose database. PostGIS is used for geospatial indexing and functions. AWS SQS is used for highly performant queues.

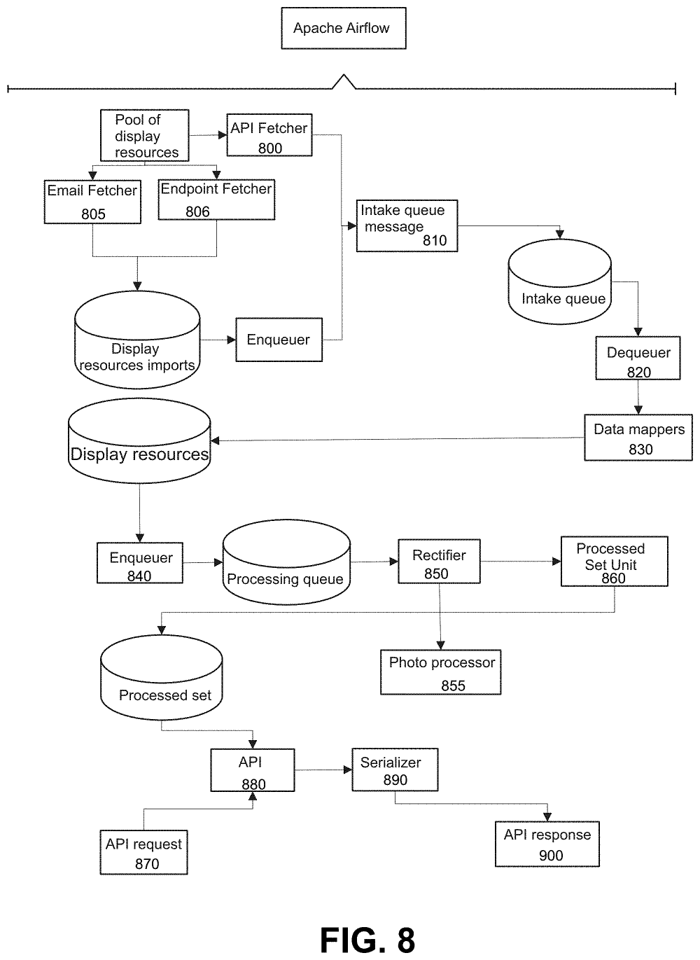

Turning now to FIG. 8, there is illustrated a flowchart of an Apache airflow process in accordance with an exemplary embodiment of the claimed invention. In step 800, new set of display resources data (or meta data) is received either by a scheduled API fetcher, persistent API connection, or pushed via a queue. The set of display resources can also be user submitted via email in step 805 or via a UI interface in step 806. In step 810, the fetchers store data as-received in the IntakeQueue.

A parallelized dequeuer process continuously pulls from the IntakeQueue in step 820 and executes the intended operation (insert, delete) against the Set of display resources database using a light data mapper to map the set of display resources to a unique identifier used as the primary key for the set record in step 830. The source data will be in whatever format it comes in.

A parallelized process constantly pulls by data source for changes in the display resources database that require reprocessing in 840. When found, it enqueues that the set in the ProcessingQueue.

In step 850, a parallelized process continually pulls from the processing queue and sends the Set of display resources to a rectifier process which:
(a) Identifies any other display resources from other data sources;
(b) Identifies the format of the data being received using a key value store file to see what keys are present in the data;
(c) Normalizes all relevant display resources to an internal data exchange format using a key value store file which can perform two-way mapping between data formats;
(d) Combines the normalized data using source priority;
(e) Applies formatting and ties in 3rd party related data;
(f) Kicks off asynchronous processing jobs such as photo processing which leverages its own queue and serverless functions to process performantly in step 855 and
(g) Outputs a processed information for a display device.

The processed information for a display device is stored in the ProcessedSet database instep 860. An API request is made to the API server which sits on top of ProcessedSet in step 870. A security token is validated for the request.

The API process fetches data based on search criteria in step 880 and filters through a serializer depending on which fields are required (e.g., latitude, longitude, and id for simple mapping) in step 890. In step 900, the data is sent via HTTP back to the information emitter 320 making the request.

This process can be used in conjunction with Pilot (automated subset recommendations based on user defined metrics, important weighting, and constraints) to automatically kick off a new recommendation based on up to date information automatically.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system to dynamically generate, monitor and optimize an allocation of resources, comprising:
a database aggregating a set of available display devices from a plurality of display resource controllers;
a plurality of processor-based client devices, each client device is associated with an information emitter or a display resource controller;
a communications network;
a processor-based server processes requests received from the client devices over said communications network, and comprises:
a load balancer to decode the requests from said plurality of client devices, and transports responses to said plurality of client devices; and
a server processor configured to:
generate the allocation of resources comprising one or more display devices selected based on an allocation criteria of the information emitter, target rating point goal, a geolocation, a format and a quality coefficient of each display device in the set of available display devices;
monitor availability of previously unavailable display devices, and update the set of available display devices;
track real-time changes to the quality coefficient for said each display device in the updated set of available display devices to provide an updated quality coefficient for said each display device in the updated set of available display devices; and
dynamically update and optimize the allocation of resources based on the updated quality coefficient of said each display device in the updated set of available display devices.

2. The system of claim 1, wherein the server processor determines the quality coefficient of said each display device from a weighted arithmetic mean of a set of quality coefficient derived from metadata or metrics of said each display device.

3. The system of claim 1, wherein the format of said each display device is a digital or non-digital display device; and wherein the server processor is configured to dynamically update and optimize prior to an activation of the allocation of resources for a set of non-digital display devices.

4. The system of claim 1, wherein the processor-based server further comprises:
a plurality of web servers to process the requests, extract data from the requests and generate a response to each request; and
at least one postgres server stores extracted data received from said plurality of web servers and provides stored data to said plurality of web servers.

5. The system of claim 1, further comprising two postgres servers in a master and slave configuration.

6. The system of claim 1, wherein the postgres server comprises a persistent storage device or a database.

7. The system of claim 1, wherein the responses are HTML templates.

8. The system of claim 4, wherein a request comprises an HTML template populated with information by an information emitter or a display resource controller.

9. The system of claim 1, wherein said plurality of web servers are configured to generate Resque jobs.

10. The system of claim 9, further comprising a Redis server that associates a key to each Resque job.

11. The system of claim 10, wherein each Resque worker polls the Redis server to retrieve the key and performs a predefined job based on the retrieved key.

12. The system of claim 1, wherein the processor-based server further comprises at least one or more of the following proposal engines:
a criteria definer to define one or more criteria for selecting one or more display devices;
an information gatherer to define information related to the information emitter and the allocation of resources;
a display device set searcher to provide a selectable pool of display devices;
a display device selector to select one or more display devices from the selectable pool of display devices;
a POI definer to define one or more places of interest or reference locations;
a mapper to map said one or more display devices to an interactive map;
a proposal assembler to assemble said information related to the information emitter, the allocation of resources, the interactive map, said one or more display device into a proposal;
a proposal viewer to access the proposals by the client devices; and
a notification engine to provide notifications to the information emitter and the display resource controller via their respective client devices.

13. The system of claim 1, wherein the requests are HTTP requests and are transported over the communications network using a TCP protocol.

14. The system of claim 1, wherein the server processor is configured to track real-time changes to the quality coefficient for each display device selected for the allocation of resources.

15. A method for dynamically generating, monitoring and optimizing an allocation of resources, comprising:
aggregating a set of available display devices from a plurality of display resource controller in a database;
processing requests received from a plurality of client devices over a communications network by a processor-based server, each client device being uniquely associated with a information emitter or a display resource controller;
decoding the requests from said plurality of client devices, and transporting responses to said plurality of client devices by a load balancer of the server;
generating the allocation of resources comprising one or more display devices selected based on an allocation criterion of the information emitter, target rating point goal, a geolocation, a format and a quality coefficient of each display device in the set of available display devices;
monitoring availability of previously unavailable display devices and updating the set of available display devices;
tracking real-time changes to the quality coefficient for said each display device in the updated set of available display devices to provide an updated quality coefficient for said each display device in the updated set of available display devices; and
dynamically updating and optimizing the allocation of resources based on the updated quality coefficient of said each display device in the updated set of available display devices.
